(19) United States
(12) Patent Application Publication
(10) Pub. No.: US 2020/0201867 A1
(43) Pub. Date: Jun. 25, 2020

(54) INSERTING ANNOTATIONS FOR APPLICATION TRACING

(71) Applicant: Intermix Software, Inc., San Francisco, CA (US)

(72) Inventors: Paul Lappas, San Francisco, CA (US); Stefan Gromoll, Hopewell, NJ (US); Luke Gotszling, San Francisco, CA (US); Lars Kamp, San Francisco, CA (US)

(21) Appl. No.: 16/264,503

(22) Filed: Jan. 31, 2019

Related U.S. Application Data
(60) Provisional application No. 62/782,660, filed on Dec. 20, 2018.

(51) Int. Cl. G06F 16/2457; G06F 16/242; G06F 16/2455; G06F 16/248; G06F 16/22; G06F 9/445

(52) U.S. Cl. CPC G06F 16/24573; G06F 16/244; G06F 9/44526; G06F 16/248; G06F 16/2282; G06F 16/2455

(57) ABSTRACT

Some embodiments of the invention provide a system including agents for inserting annotations into query text of queries run on a set of tables in a set of databases by applications on which the agents are installed, a collector that collects and processes metadata regarding the queries and tables queried, a metadata aggregator that receives the query metadata processed by the collector and aggregates the received query metadata based on a grouping of queries along a shared query metadata attribute that is derived from the query annotation included in the query text data, and a display generator that generates a display of query execution performance for each of a plurality of groups of queries, the plurality of groups having a same value associated with a first query metadata attribute, each group of queries in the plurality of groups of queries having a different value associated with a second query metadata attribute.

### BACKGROUND

Companies currently produce large amounts of data. This data is produced in many formats from many sources. Companies desiring to use this data for machine learning, to improve their products, or for artificial intelligence applications must collect the data and put it into a format that is able to be analyzed. Data is not only collected from different sources in different formats but is also transformed into a consistent, valid set of data in a data storage. The process for collecting and transforming the data often involves many applications running multiple queries (e.g., SQL queries) to different databases to perform query operations (e.g., extract, transform, load (ETL) operations, reporting operations, and data integration applications). SQL queries use a set of keywords that have specific meanings and make up SQL statements. SQL statements include these keywords as well as identifiers of schema, tables, and columns to be accessed and terms or expressions specifying, for example, content to be searched for and the schemas, tables, and columns to search. Some databases (e.g., Presto, Snowflake, Amazon Redshift or Athena) and analytic SQL query engines have additional keywords that may be used to perform additional functions as part of a query of the database. The different sets of processes for a single purpose (e.g., collecting and normalizing data for machine learning, or just the extraction process for an eventual machine learning application) are often referred to as pipelines. Keeping track of the information flows (i.e., pipelines, extraction operations, load operations, analysis or retrieval operations) and the performance of the different information flows to monitor the system's performance presents a major issue. A solution for monitoring the performance of the system as a whole and the elements (e.g., individual tasks or queries) of the system to pinpoint any bottlenecks or other problems is required.

### BRIEF SUMMARY

Some embodiments of the invention provide a system including agents for inserting annotations into query text of queries run on a set of tables in a set of databases by applications on which the agents are installed or otherwise integrated with, a collector that collects and processes metadata regarding the queries and tables queried, a metadata aggregator that receives the query metadata processed by the collector and aggregates the received query metadata based on a grouping of queries along a shared query metadata attribute that is derived from the query annotation included in the query text data, and a display generator that generates a display of query execution performance for each of a plurality of groups of queries, the plurality of groups having a same value associated with a first query metadata attribute, each group of queries in the plurality of groups of queries having a different value associated with a second query metadata attribute.

Agents, in some embodiments, are plugins to existing applications. In other embodiments, the agents are part of an application running queries on the tables and databases. Annotations inserted by the agents of different applications, in some embodiments, have different formats and include values for different metadata attributes. In some embodiments, multiple annotations are inserted by an application. For example, an application inserts annotations associated with the application along with an annotation defined or specified by an agent of the present system. Annotations include some combination of values or identifiers of an identity of an originating application, a user of the application, a task related to the query, a group associated with the query, a dashboard associated with the query, a version of the originating application, and a time that the query was executed, in some embodiments. Annotations, in some embodiments, also include values or identifiers for additional metadata attributes that are application-specific or that are requested by a user (e.g., user-created security group, work group, business division, etc.). In some embodiments, annotations are written in a compressed (e.g., as 64-bit hexadecimal code), proprietary, or encrypted format.

The collector of the system collects data regarding the queries. The collector, in some embodiments, is a cluster of collectors that interface with a set of databases and other data storage to collect the data from, and for, the other components of the system. In some embodiments, the collectors collect data from databases (e.g., Amazon Redshift or S3) that provide specific information about queries run on the databases. In some embodiments, this data includes the query text, a latency of the query (e.g., in terms of a start and end time of the query execution, or as a single value indicating how long the query took to complete), a queuing time, processing resources used in executing the query (e.g., CPU time), memory used in executing the query, rows accessed in executing the query, and errors in executing the query (including aborted queries). In some embodiments, query text is collected from the applications running the queries.

The collector, in some embodiments, is deployed within a secure system and includes separate modules (1) for loading data into a secure storage area (e.g., a secure storage lake, or bucket within a data lake) within the secure system and (2) for scrubbing the collected data of any potential personally identifiable information (PII) before collected data is placed in a storage area that is accessible from the elements of the system running outside the secure system (e.g., the metadata aggregator and display generator). The scrubbing module, in some embodiments, also processes the collected data to extract additional metadata using additional modules such as a query parser to identify query groups (e.g., queries accessing certain tables to extract certain information every 15 minutes) based on the structure of collected query text, a table touch parser to determine tables accessed by each query based on parsing the query text, and metadata included in the annotations using an annotation parser that parses the annotations. In some embodiments, the collector also collects table metadata expressing attributes of the table during a time period that is associated with the plurality of queries. Table metadata, in some embodiments, is collected for all tables of the database (e.g., the entire catalog). The table metadata for a particular table, in some embodiments, includes information relating to at least one of a size of the table (e.g., in memory or on disk), the number of rows in the table, the number of columns in the table, the table name, the name of the schema including the table (i.e., the schema in which the table exists), the name of the database including the table (i.e., the name of the database in which the table is stored), the skew of the table, the distribution style, the distribution key, the sorting style, and the fraction of the table that is sorted.

The metadata aggregator receives data (e.g., query and table metadata) collected and processed by the collector. The metadata aggregator, in some embodiments, aggregates the received query metadata based on a grouping of queries along a shared query metadata attribute that is derived from the query annotation included in the query text data. In some embodiments, the metadata aggregator populates a database based on the query and table metadata attributes. For example, a database including columns for each query metadata attribute (e.g., any or all of query latency, queuing latency, resource usage, originating application, task, query group, dashboard, tables accessed, etc.) is populated with data from the query and table metadata attributes. In some embodiments, the collector provides only a portion of the query and table metadata (e.g., query performance data, query text data, and table attributes) while the metadata aggregator includes the query parser, table touch parser, and annotation parser modules that extract extra metadata as described above. In some embodiments, the different parser modules are split between the collector and the metadata aggregator in different ways for efficiency (e.g., having the query parser operate as part of the scrubbing operation so that query text is parsed only once). In some embodiments, the different parser modules are combined in a single module that parses the entire query for identifying query groups, identifying tables accessed by the queries, and parsing the annotations.

The display generator, in some embodiments, generates a display of query execution performance (e.g., a first graph of query count over time, a second graph of query latency over time, and a third graph of query queuing time over time) for each of a plurality of groups of queries, the plurality of groups having a same value associated with a first query metadata attribute, each group of queries in the plurality of groups of queries having a different value associated with a second query metadata attribute. In some embodiments, a first display is generated that presents a summary of the performance data for the plurality of groups as a whole. The first display, in some embodiments, also includes selectable menus (e.g., dropdown menus) for selecting different metadata attribute values (e.g., selecting an application, task, etc.) for display as subcategories within the summary display. Additional dropdown menus are provided, in some embodiments, to select a single value associated with a metadata attribute to provide further details regarding the query performance. For each of a set of additional displays generated, the same dropdown menus will be provided to provide the user an ability to see further subcategories within the summary display for the selected value associated with the metadata attribute.

In some embodiments, additional displays (e.g., types of views and dashboards) are generated to provide details regarding certain groupings of queries (e.g., query groups). In some embodiments, these additional displays include identification of, for example, a set of query groups with the highest value for, or highest percent change in, any or all of query latency, query count, and queuing time. Other generated displays, in some embodiments, include displays relating to table attributes (e.g., table row count over time or table size (e.g., in memory or on disk) over time). These additional displays are used, in some embodiments, to provide further insight into issues with specific queries and data pipelines. For example, identifying a table that is rapidly increasing in row count and significantly slowing down a particular query in a data processing pipeline for a machine learning application.

Some embodiments provide user interfaces including application programming interfaces (APIs) and dashboards for users to interact with the metadata aggregator and to modify the generated display. In some embodiments, the APIs are also used to specify the metadata fields included in query annotations by the agents installed in the applications responsible for queries. Dashboards are also provided, in some embodiments, to allow users to view the generated displays and modify the displays as described above. In some embodiments, the dashboards are accessed through a web browser or thin client by a user.

In some embodiments, the insight provided by the above system can be used to provide information for security-related purposes. For example, by selecting a specific user by which to organize the displayed data, an administrator can see what queries an ex-employee was accessing shortly before they left in order to ensure they were not accessing information outside of the scope of their responsibilities or identify any sensitive information they may have been accessing and taken with them upon leaving. Additionally, the number of queries or CPU or memory resources used can be broken down by user group (e.g., business division) to apportion the cost for database and other information services according to their use.

The preceding Summary is intended to serve as a brief introduction to some embodiments of the invention. It is not meant to be an introduction or overview of all inventive subject matter disclosed in this document. The Detailed Description that follows and the Drawings that are referred to in the Detailed Description will further describe the embodiments described in the Summary as well as other embodiments. Accordingly, to understand all the embodiments described by this document, a full review of the Summary, Detailed Description, and the Drawings is needed. Moreover, the claimed subject matters are not to be limited by the illustrative details in the Summary, Detailed Description, and the Drawings.

### BRIEF DESCRIPTION OF THE DRAWINGS

The novel features of the invention are set forth in the appended claims. However, for purposes of explanation, several embodiments of the invention are set forth in the following figures.

FIG. 1 illustrates an embodiment of the system.

FIG. 2 conceptually illustrates a process for aggregating metadata regarding multiple queries.

FIG. 3 conceptually illustrates a process for parsing query text to identify query groups.

FIG. 4 illustrates an exemplary received query text being processed to identify a query group.

FIG. 5 conceptually illustrates a process for parsing query text to identify tables (and columns and schema) accessed by a query

FIG. 6 illustrates an exemplary received query text being processed to identify a table accessed by the query.

FIG. 7 conceptually illustrates a process for parsing query annotations to identify values associated with metadata attributes included in the annotations.

FIG. 8 illustrates an exemplary received query metadata including query identifier and annotation being processed to identify values for the metadata attributes included in the annotation data.

FIG. 9 illustrates a second embodiment of a system.

FIG. 10 illustrates a third embodiment of a system.

FIG. 11 conceptually illustrates a process for a collector to perform to collect and process metadata from databases.

FIG. 12 illustrates a fourth embodiment of a system.

FIG. 13 conceptually illustrates a process for a collector to perform to collect and process metadata from databases.

FIG. 14 illustrates an embodiment of a first display screen that presents a set of graphs (query count, query latency, and queuing latency) for a plurality of queries.

FIG. 15 illustrates a second embodiment of a generated display that displays information regarding query groups that have had the most significant changes in a specified period of time.

FIG. 16 illustrates graph of latency (e.g., average latency) over time for a group of queries.

FIG. 17 illustrates a graph showing the latency for all queries executed by a particular application.

FIG. 18 illustrates a graph showing the latency for all queries of a DAG and then further visualizing the breakdown of latency by task.

FIG. 19 illustrates a graph showing the latency for all queries of a task and then further visualizing the breakdown of latency by query group.

FIG. 20 illustrates a display of table metadata including a graph of table size (in memory) and a graph of table row count.

FIG. 21 conceptually illustrates an electronic system with which some embodiments of the invention are implemented.

### DETAILED DESCRIPTION

Some embodiments of the invention provide a system including agents for inserting annotations into query text of queries run on a set of tables in a set of databases by applications on which the agents are installed or otherwise integrated with, a collector that collects and processes metadata regarding the queries and tables queried, a metadata aggregator that receives the query metadata processed by the collector and aggregates the received query metadata based on a grouping of queries along a shared query metadata attribute that is derived from the query annotation included in the query text data, and a display generator that generates a display of query execution performance for each of a plurality of groups of queries, the plurality of groups having a same value associated with a first query metadata attribute, each group of queries in the plurality of groups of queries having a different value associated with a second query metadata attribute.

In the following detailed description of the invention, numerous details, examples, and embodiments of the invention are set forth and described. However, it will be clear and apparent to one skilled in the art that the invention is not limited to the embodiments set forth and that the invention may be practiced without some of the specific details and examples discussed.

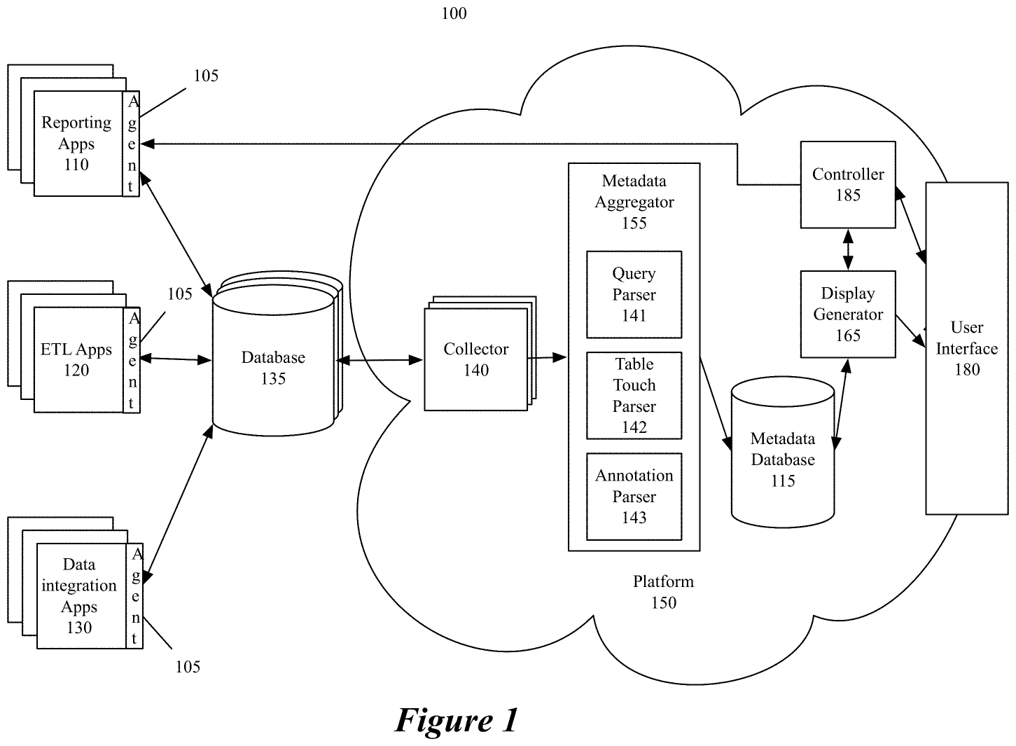

FIGS. 1, 9, 10, and 12 illustrate different embodiments of the invention using different configurations of system elements. Similar elements of FIGS. 1, 9, 10, and 12 use similar numbering convention wherever possible. FIG. 1 illustrates an embodiment of the system 100. System 100 includes a set of agents 105 installed in a set of applications including reporting applications 110, extract, transform, load (ETL) applications 120, and data integration applications 130. The applications 110, 120, and 130 query databases 135 (e.g., tables in databases 135) as part of data pipelines. Queries include accessing a set of tables to read and/or write data from the set of tables. Different queries access different tables for different purposes and, in some embodiments, access only certain portions of tables (e.g., only certain rows or certain columns of a table). The agents 105 installed on the applications 110, 120, and 130, in some embodiments, are plugins installed in the applications by a user of the application in order to take advantage of system 100 to provide insight into data flows and data pipelines. In other embodiments, agents 105 are included in the application itself so as to be compatible with system 100 without further configuration. Some embodiments include a mix of installed agents and agents that are part of the applications. Agents, in each embodiment, insert annotations into query text that include a set of values associated with query metadata attributes. For example, an agent executing on a Looker application inserts, in some embodiments, values for metadata attributes including an originating application (i.e., Looker), a user of the application, a task related to the query, a group associated with the query, a directed acyclic group identifier, a dashboard associated with the query, a version of the application responsible for the query, and a time that the query was run. In some embodiments, multiple annotations are inserted by an application. For example, an application inserts an annotation associated with the application along with an annotation defined or specified by an agent of the present system. Annotations, in some embodiments, also include values or identifiers for additional metadata attributes that are application-specific or that are requested by a user (e.g., user-created security group, work group, business division, etc.). In some embodiments, annotations are written in a compressed (e.g., as 64-bit hexadecimal code), proprietary, or encrypted format. Attribute annotations, in some embodiments, include a set of fields including at least one of query, endtime, format, version, annotation, aggregation, app, app_ver, at, chart_name, dashboard_id, history_id, meta, plugin, plugin_ver, query_source, url, user, user_cat_refresh, user_email, user_id, dag, task, classname, file, function, linenumber, module, explore, instance_slug, model, chart_id, dashboard_slug, datasource_id, is_manual, organization_id, reason,m pdt_name, query_hash, query_id, queue, task_id, username, and pipeline_id fields.

Databases 135, in some embodiments, include different types of databases (e.g., relational databases) and may be located in different locations (e.g., local datacenters, Amazon redshift or simple storage service (S3), Microsoft Azure SQL Database, etc.). Databases, in some embodiments, are configured to provide query performance data for queries run on tables in the database. In some embodiments, query performance data for a query includes at least one of: a user identifier, a query identifier, a transaction ID, a process ID, a name of a database the user was connected to when the query was issued, the text of the query, a latency of the query (either as a single value for the time to execute the query or inferred from a beginning and ending time of the query execution), a queueing time (i.e., a time between receiving a query and executing the query), resources (e.g., CPU) used in executing the query, memory used in executing the query, rows accessed in executing the query, errors in executing the query, and a value that indicates whether table writes were allowed during query execution. Databases 135, in some embodiments, are configured to provide additional query performance data.

Query performance data, including query text data, is collected from databases 135, and in some embodiments from applications 110, 120, and 130, by collectors 140. In some embodiments, collectors 140 are a set of collectors that each interact with a particular database in the set of databases 135. Collectors 140, in some embodiments, process collected data to normalize the data or otherwise format the data into a consistent format for the other elements of the system 100 to use. Other processing operations performed in some embodiments are described below. Once collected and processed, the data is provided to a metadata aggregator 155. In some embodiments, collectors 140 also collect table metadata expressing attributes of the table during a time period that is associated with the plurality of queries. The table metadata for a particular table, in some embodiments, includes information relating to at least one of a size of the table in memory, the number of rows in the table, the number of columns in the table, and the fraction of the table that is sorted.

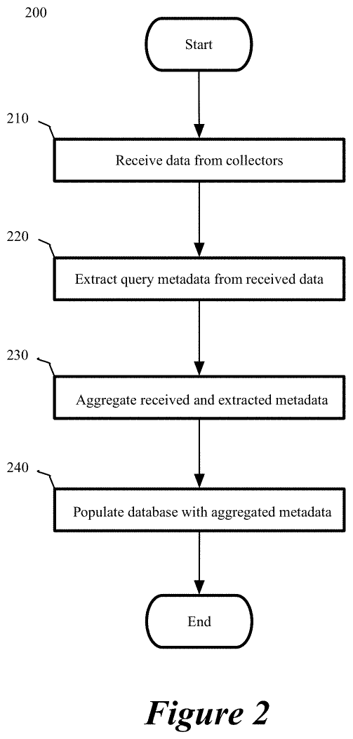

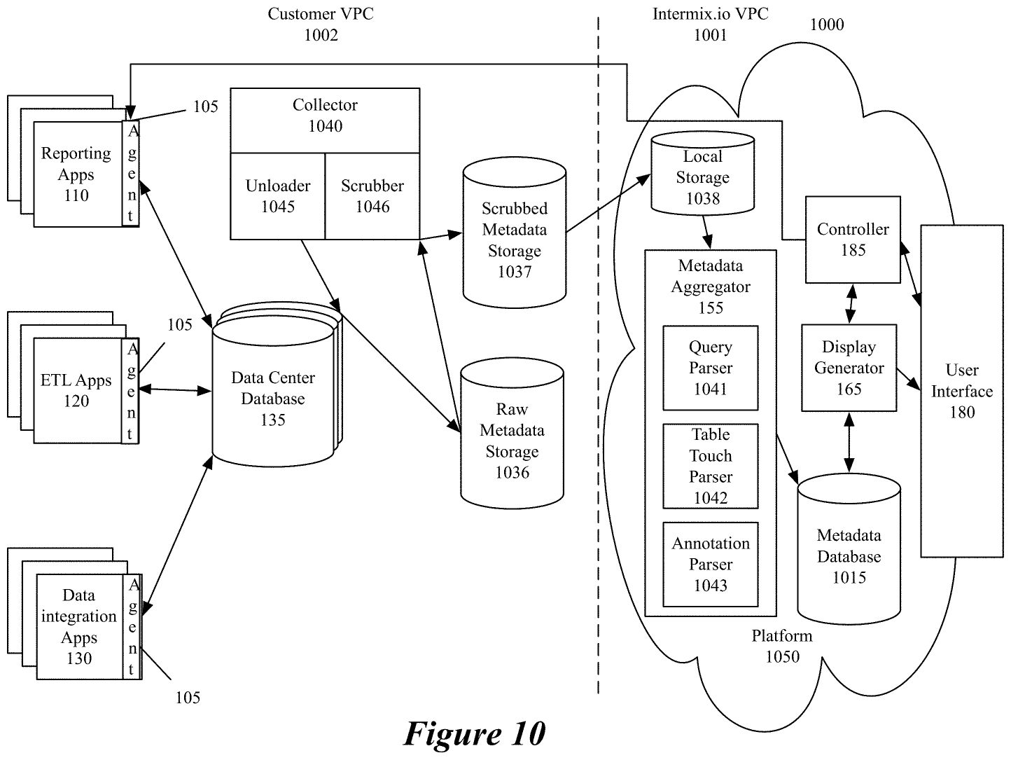

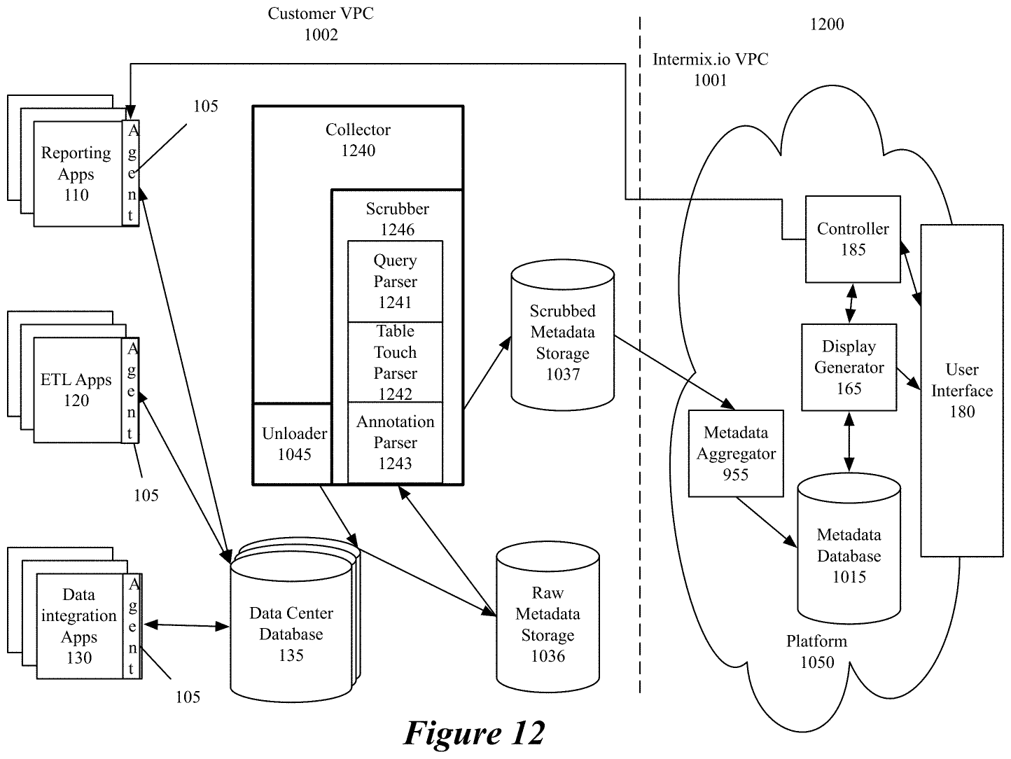

Metadata aggregator 155 receives the data (e.g., query and table metadata) collected and processed by collectors 140. Metadata aggregator 155, in some embodiments, aggregates the received query metadata based on a grouping of queries along a shared query metadata attribute that is derived from the query annotation included in the query text data and the query metadata. FIG. 2 conceptually illustrates process 200 for aggregating metadata regarding multiple queries. Process 200 is performed, in some embodiments, by metadata aggregator 155. In some embodiments, process 200 begins when metadata aggregator 155 receives (at 210) query (and table) metadata from collectors 140. In other embodiments, described below in relation to FIGS. 10 and 12 the data received from collectors 140 is received through a set of storages used to preserve sensitive data.

After receiving the query (and table) metadata, the metadata aggregator extracts (at 220) additional metadata using additional modules such as query parser 141, table touch parser 142, and annotation parser 143. Query parser 141, in some embodiments, identifies query groups (e.g., queries accessing certain tables to extract certain information every 15 minutes) based on the structure of collected query text. Table touch parser 142, in some embodiments, determine tables accessed by each query based on parsing the query text to identify all the tables specified in the query. Annotation parser 143, in some embodiments, parses the annotations to extract metadata inserted into the annotation by an application or agent installed on an application.

After extracting the additional metadata, metadata aggregator 155 aggregates (at 230) the received and extracted metadata. In some embodiments, a query ID received as part of the query metadata from databases 135 is used to aggregate data from the different modules to create a single entry (e.g., row in a table) for a particular query that includes values for all the different attributes of a query (e.g., query metadata attributes from databases 135, annotation metadata attributes, query group, tables accessed, etc.) that is used by a user of system 100 to perform analysis of the different data pipelines and flows in system 100.

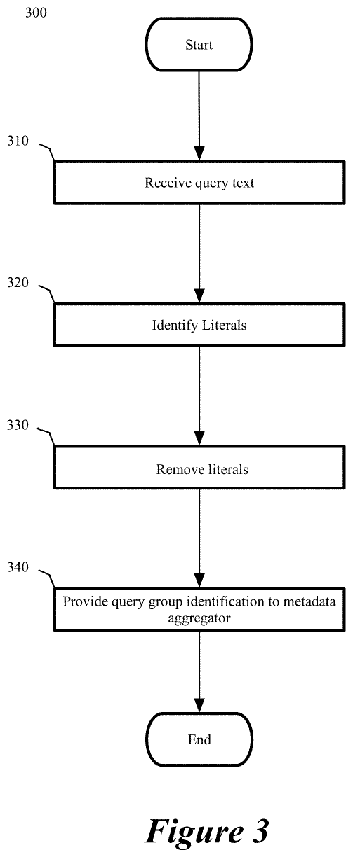

Once metadata has been aggregated, metadata aggregator 155 populates (at 240) a database (e.g., metadata database 115) with the aggregated metadata. For example, a database (or table in the database) is populated with data from the query, table, and extracted metadata attributes in rows for each query including columns for each metadata attribute relating to the query (e.g., any or all of query latency, queuing latency, resource usage, originating application, task, query group, dashboard, tables accessed, etc.). In some embodiments, the different parser modules 141-143 are combined in a single module that parses the entire query for identifying query groups, identifying tables accessed by the queries, and parsing the annotations. Processes for individual parser modules are further described in relation to FIGS. 3-8.

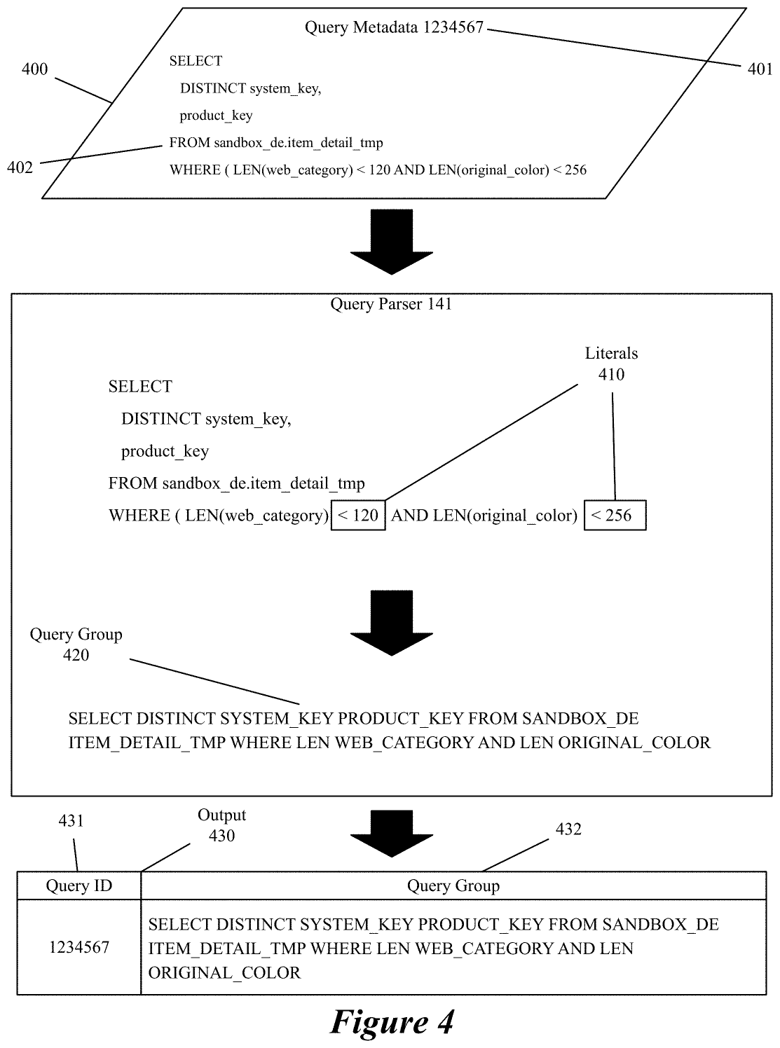

FIG. 3 conceptually illustrates process 300 for parsing query text to identify query groups. In some embodiments, process 300 is performed by a query parser executing in one of a metadata aggregator or collector. FIG. 3 and process 300 will be described in conjunction with FIG. 4 which illustrates an exemplary received query text 400 being processed to identify a query group. Process 300 begins by receiving (at 310) query text for a particular query, for example query text 402 for query 400 with query ID 401 (i.e., 1234567). The query text, in some embodiments, is included as part of query metadata and is extracted by query parser 141, while in other embodiments, different components of the query metadata are separated and passed to different parser modules based on the functionality of the parser module by a pre-parser (not shown). In some embodiments, the query text includes comments, including annotations, but because query parser 141 ignores non-functional text in a received query, comments and annotations have been omitted.

Process 300 then identifies (at 320) and removes (at 330) literals (e.g., values or text to be searched for specified by the user and operators (“=”, “<”, “>”, etc.) expressing conditions, etc.). For example, query parser 141 of FIG. 4 identifies the expressions “<120” and “<256” as literals 410. Literals 410 are removed to produce query group text 420. In some embodiments, query group text 420 is used as the identifier 432 for the query group. Query group text includes both the SQL (or other query language) commands as well as the names of tables accessed by the query and the type of data being searched (e.g., query 400 queries sandbox_de.item_detail_tmp for entries for which the length of “web_category” is less than 120 and the length of “original_color” is less than 256).

Once the literals are removed, the query group identifier is provided (at 340) to the metadata aggregator for aggregation with the received query metadata and the additional extracted metadata. In some embodiments, the output to the metadata aggregator includes the identifier of the query (e.g., 431) provided by the database as query metadata to allow the metadata aggregator to aggregate the output of the different parser modules based on the associated query ID. Once the output is provided, for example to the metadata aggregator or other next step in a processing pipeline, the process ends.

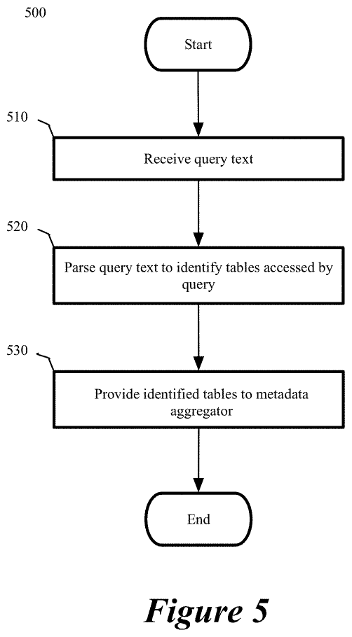

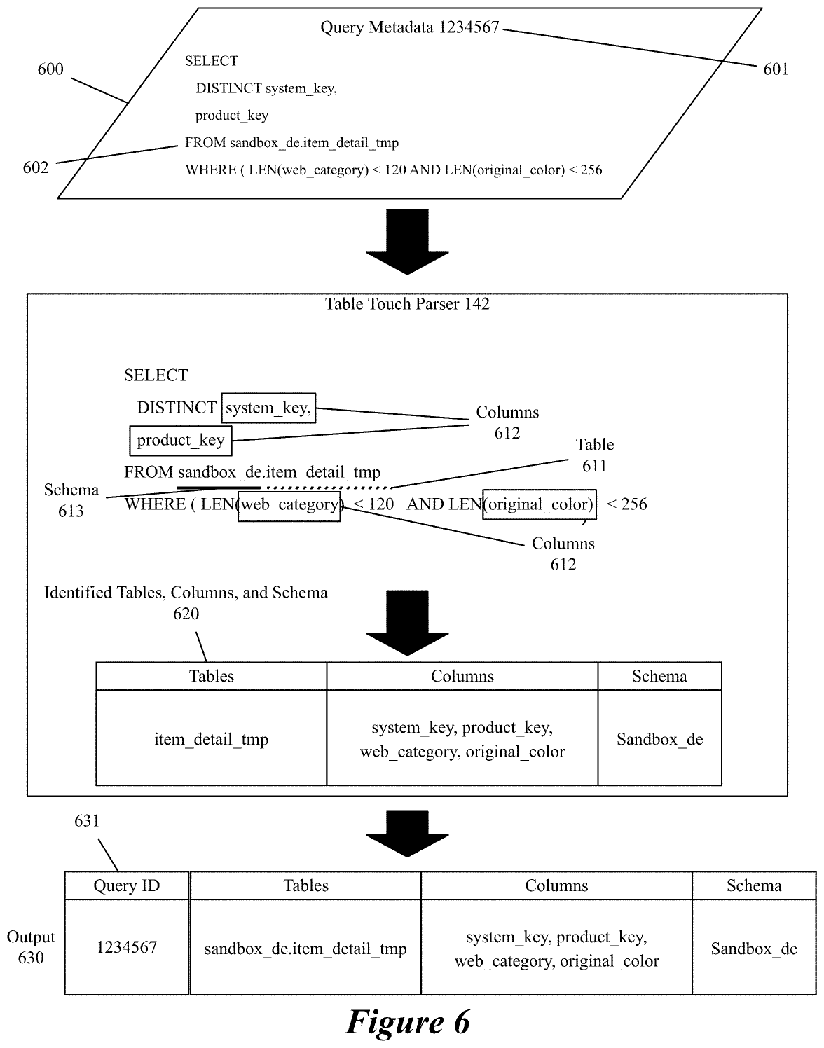

FIG. 5 conceptually illustrates process 500 for parsing query text to identify tables (and columns and schema) accessed by a query. In some embodiments, process 500 is performed by a table touch parser executing in one of a metadata aggregator or collector. FIG. 5 and process 500 will be described in conjunction with FIG. 6 which illustrates an exemplary received query text 600 being processed to identify a table accessed by the query. Process 500 begins by receiving (at 510) query text for a particular query, for example query text 602 for query 600 with query ID 601 (i.e., 1234567). The query text, in some embodiments, is included as part of query metadata and is extracted by table touch parser 142, while in other embodiments, different components of the query metadata are separated and passed to different parser modules based on the functionality of the parser module by a pre-parser (not shown). In some embodiments, the query text includes comments, including annotations, but because table touch parser 142 ignores non-functional text in a received query, comments and annotations have been omitted.

Process 500 then identifies (at 520) tables accessed by a query (e.g., query 600). In some embodiments, in addition to identifying tables, process 500 identifies (at 520) schemas to which the tables belong and columns of the tables that are accessed. Schemas, in some embodiments, identify a user or owner of a table. For example, table touch parser 142 of FIG. 6 identifies the term “sandbox_de.item_detail_tmp” as identifying a schema “sandbox_de” 613 and a table “item_detail_tmp” 611 accessed and the terms “system_key,” “product_key,” “web_category,” and “original_color” as columns 612 of the table that are accessed. In some embodiments, identifying the tables, columns, and schemas includes (1) decomposing the text into a series of parsable statements, (2) generating a parse tree of the query (e.g., by leveraging the Postgres library with custom code to handle database-specific query language) (3) traversing the parse tree and, at each step, (i) storing a schema in working memory if encountered and (ii) counting each access based on the type of query keyword that is being invoked at that step of the query (without storing duplicates) while utilizing the schema from working memory if available, and (4) generating a result set to be provided to the metadata aggregator. In some embodiments, query keywords analyzed or counted by table touch parser 142 include “create,” “delete,” “group,” “insert,” “join,” “order,” “select,” “update,” and “where.”

Once the tables (and columns, schemas, query keywords, etc.) are identified, the identified tables are provided (at 530) to metadata aggregator to be aggregated with other metadata associated with the query. In some embodiments, the output (e.g., 630) to the metadata aggregator includes the identifier of the query (e.g., 631) provided by the database as query metadata to allow the metadata aggregator to aggregate the output of the table touch parser with the metadata received from the database or from other parsing modules. Once the output is provided, for example to the metadata aggregator or other next step in a processing pipeline, the process ends.

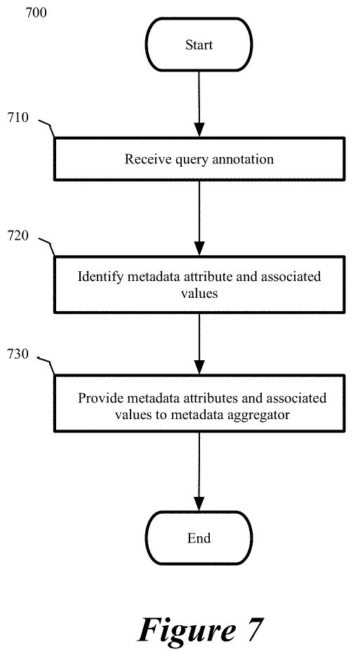

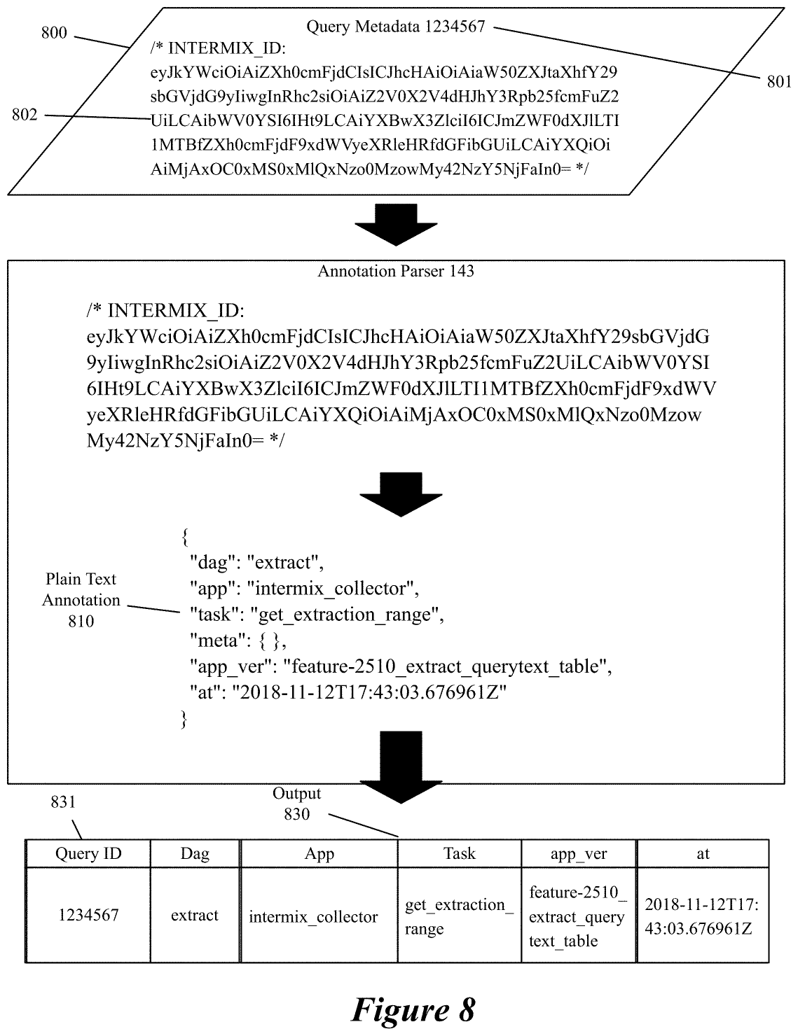

FIG. 7 conceptually illustrates process 700 for parsing query annotations to identify values associated with metadata attributes included in the annotations. In some embodiments, process 300 is performed by an annotation parser executing in one of a metadata aggregator or collector. FIG. 7 and process 700 will be described in conjunction with FIG. 8 which illustrates an exemplary received query metadata 800 including query identifier 801 and annotation 802 being processed to identify values for the metadata attributes included in the annotation data. Process 700 begins by receiving (at 710) a query annotation for a particular query, for example query annotation 802 for query 800 with query ID 801 (i.e., 1234567). The query annotation, in some embodiments, is included as part of query metadata and is extracted by annotation parser 143, while in other embodiments, different components of the query metadata are separated and passed to different parser modules based on the functionality of the parser module by a pre-parser (not shown). In some embodiments, the query annotation includes multiple annotations from an agent and from the application itself.

Process 700 then identifies (at 720) metadata attributes and the values associated with them. As shown in FIG. 8, annotations in some embodiments are not in plain text (e.g., they are either compressed or encrypted) and must first be converted into plain text. Annotation 802 (after “intermix ID:”) is presented as 64-bit text that is converted to plain text 810. Plain text 810 indicates that the directed acyclic graph (DAG) to which the query belongs is an “extract” DAG, the application running the query is an “intermix_collector” application, the tasks is a “get_extraction_range” task, there are no additional metadata attributes added by the user or application, the app version is “feature-2510_extract_querytext_table”, and the query was run at “2018-11-12T17:43:43.676961Z.”

Once the metadata attribute values are identified, the identified values are provided (at 730) to the metadata aggregator for aggregation with the received query metadata and the additional extracted metadata. In some embodiments, the output to the metadata aggregator includes the identifier of the query (e.g., 831) provided by the database as query metadata to allow the metadata aggregator to aggregate the output of the different parser modules based on the associated query ID. Once the output is provided, for example to the metadata aggregator or other next step in a processing pipeline, the process ends.

Display generator 165, in some embodiments, generates a display of query execution performance (e.g., a first graph of query count over time, a second graph of query latency over time, and a third graph of query queuing time over time) for each of a plurality of groups of queries, the plurality of groups having a same value associated with a first query metadata attribute, each group of queries in the plurality of groups of queries having a different value associated with a second query metadata attribute. In some embodiments, a first display is generated that presents a summary of the performance data for the plurality of groups as a whole. The first display, in some embodiments, also includes selectable menus (e.g., dropdown menus) for selecting different metadata attribute values (e.g., selecting an application, task, etc.) for display as subcategories within the summary display. Additional dropdown menus are provided, in some embodiments, to select a single value associated with a metadata attribute to provide further details regarding the query performance. For example, from a first display displaying data for all the queries run by the system, a user can filter the data to select a particular attribute (e.g., application, directed acyclic graph (DAG), task, query group, etc.) to trigger the generation of a second display for queries with the particular attribute. For each of a set of additional displays generated, in some embodiments, the same dropdown menus will be provided to provide the user an ability to filter the data or see further subcategories within the summary display for the selected value associated with the metadata attribute.

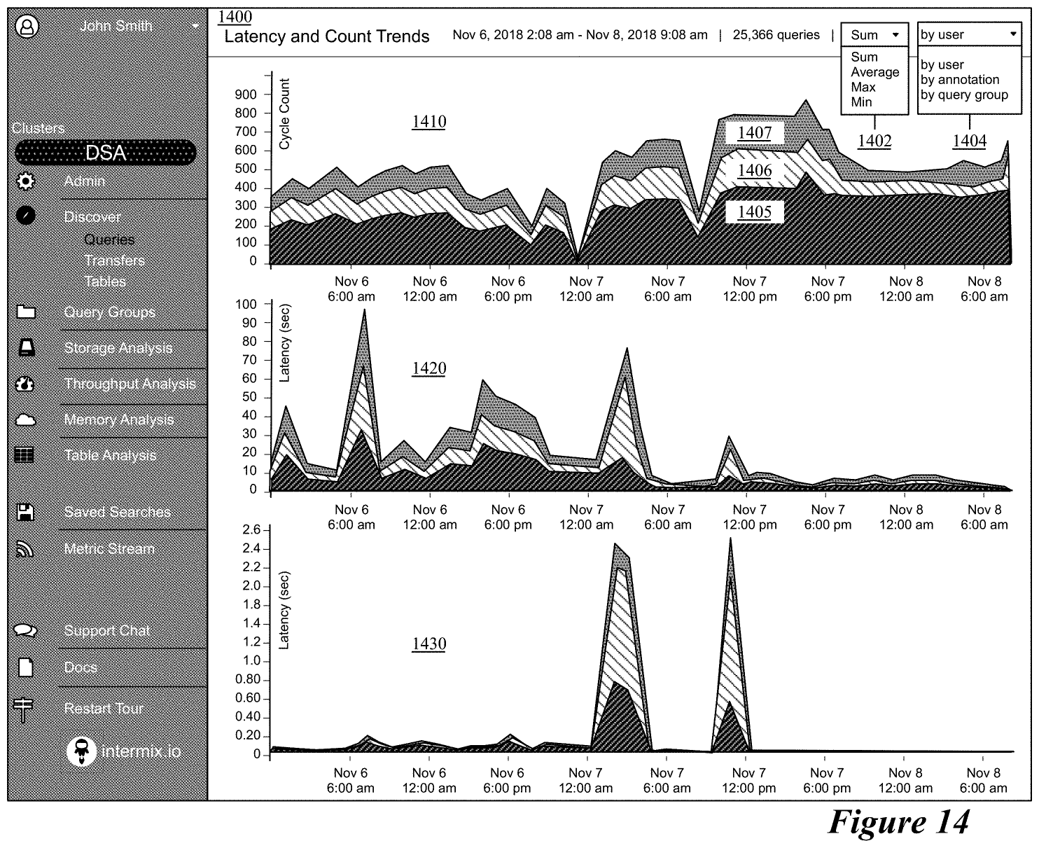

In some embodiments, additional displays (e.g., types of views and dashboards) are generated by display generator 165 to provide details regarding certain groupings of queries (e.g., applications, query groups, etc.). In some embodiments, these additional displays include identification of, for example, a set of query groups with the highest value for, or highest percent change in, any or all of query latency, query count, and queuing time. Other generated displays, in some embodiments, include displays relating to table attributes (e.g., table row count over time or table memory usage over time). These additional displays are used, in some embodiments, to provide further insight into issues with specific queries and data pipelines. For example, identifying a table that is rapidly increasing in row count and significantly slowing down a particular query in a data processing pipeline for a machine learning application. FIGS. 14-20, discussed below, provide further details regarding generated displays.

User interface 180 provides a user the ability to interact with platform 150 to (1) control the types of data that are collected by the system and the display generator 165 through controller 185. In some embodiments, user interface 180 includes application programming interfaces (APIs) to control the types of data collected by the system and dashboards (e.g., graphical user interfaces (GUIs)) for users to interact with platform 150 and to modify the generated display. In some embodiments, the APIs are also used to specify the metadata fields included in query annotations by the agents installed in the applications responsible for queries. In some embodiments, the dashboards are accessed through a web browser or thin client by a user.

Platform 150, in some embodiments, executes in a virtual private cloud that supports the data integration and display features of system 100. As shown, collectors 140, metadata aggregator 155, metadata database 115, display generator 165, and controller 185 execute within platform 150. In some embodiments, the elements executing in platform 150 execute in multiple datacenters over which the virtual private cloud is implemented. Metadata database 115, in some embodiments, is one of a local database (set of one or more servers in the datacenters implementing the virtual private cloud) or a cloud provider database (e.g., Amazon Redshift, etc.).

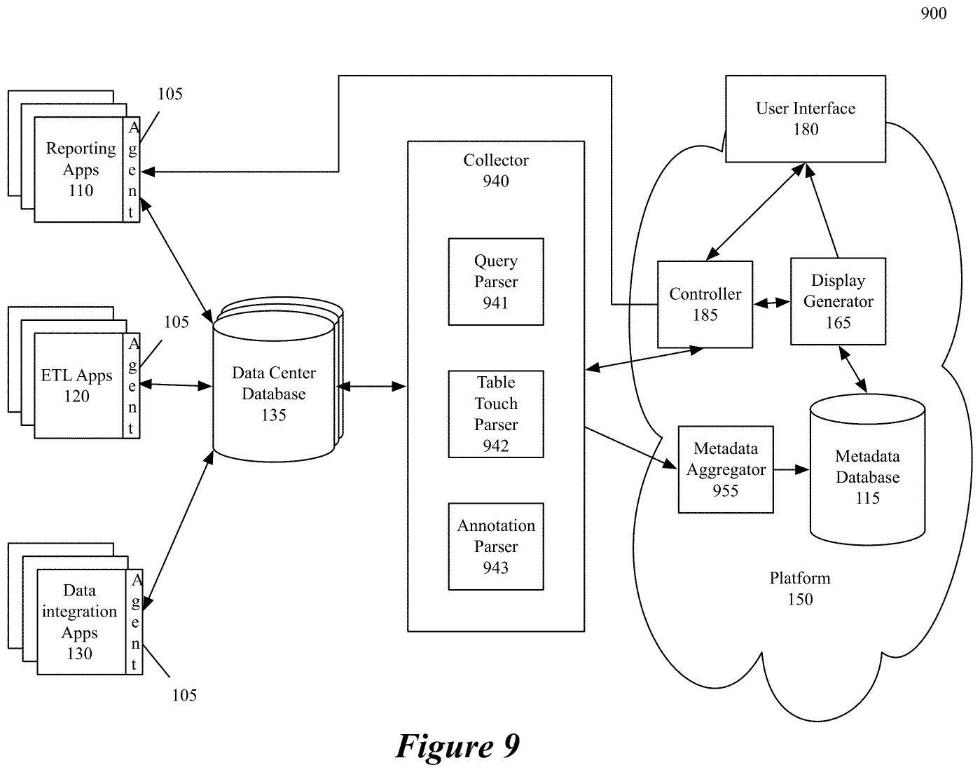

FIG. 9 illustrates a second embodiment of a system 900. System 900 includes a set of agents 105 installed in a set of applications including reporting applications 110, extract, transform, load (ETL) applications 120, and data integration applications 130. As described in relation to FIG. 1, the applications 110, 120, and 130 query databases 135 (e.g., tables in databases 135) as part of data pipelines. Queries include accessing a set of tables to read and/or write data from the set of tables. Different queries access different tables for different purposes and, in some embodiments, access only certain portions of tables (e.g., only certain rows or certain columns of a table). The agents 105 installed on the applications 110, 120, and 130, in some embodiments, are plugins installed in the applications by a user of the application in order to take advantage of system 100 to provide insight into data flows and data pipelines. In other embodiments, agents 105 are included in the application itself so as to be compatible with system 100 without further configuration. Some embodiments include a mix of installed agents and agents that are part of the applications. Agents, in each embodiment, insert annotations into query text that include a set of values associated with query metadata attributes. For example, an agent executing on a Looker application inserts, in some embodiments, values for metadata attributes including an originating application (i.e., Looker), a user of the application, a task related to the query, a group associated with the query, a dashboard associated with the query, a version of the application responsible for the query, and a time that the query was run. In some embodiments, multiple annotations are inserted by an application. For example, an application inserts an annotation associated with the application along with an annotation defined or specified by an agent of the present system. Annotations, in some embodiments, also include values or identifiers for additional metadata attributes that are application-specific or that are requested by a user (e.g., user-created security group, work group, business division, etc.). In some embodiments, annotations are written in a compressed (e.g., as 64-bit hexadecimal code), proprietary, or encrypted format.

Databases 135, in some embodiments, include different types of databases (e.g., relational databases) and may be located in different locations (e.g., local datacenters, Amazon redshift or simple storage service (S3), Microsoft Azure SQL Database, etc.). Databases, in some embodiments, are configured to provide query performance data for queries run on tables in the database. In some embodiments, query performance data for a query includes at least one of: the text of the query, a latency of the query (either as a single value for the time to execute the query or inferred from a beginning and ending time of the query execution), a queueing time (i.e., a time between receiving a query and executing the query), resources (e.g., CPU) used in executing the query, memory used in executing the query, rows accessed in executing the query, and errors in executing the query. Databases 135, in some embodiments, are configured to provide additional query performance data.

Query performance data, including query text data, is collected from databases 135, and in some embodiments from applications 110, 120, and 130, by collector 940. In some embodiments, collector 940 is a set of collectors that each interact with a particular database in the set of databases 135. Collector 940, in some embodiments, processes collected data to normalize the data or otherwise format the data into a consistent format for the other elements of the system 900 to use. In some embodiments, collector 940 also collects table metadata expressing attributes of the table during a time period that is associated with the plurality of queries. The table metadata for a particular table, in some embodiments, includes information relating to at least one of (1) a size of the table in memory, (2) the number of rows in the table, (3) the number of columns in the table, and (4) the fraction of the table that is sorted.

In some embodiments, collector 940 receives query (and table) metadata from databases 135 and extracts additional metadata using additional modules such as a query parser 941 to identify query groups (e.g., queries accessing certain tables to extract certain information every 15 minutes) based on the structure of collected query text, a table touch parser 942 to determine tables accessed by each query based on parsing the query text, and an annotation parser 943 to parse the annotations to extract annotation metadata. Once collected and processed, the data is provided to a metadata aggregator 955. In some embodiments, the different parser modules 941-943 are combined in a single module that parses the entire query for identifying query groups, identifying tables accessed by the queries, and parsing the annotations. As shown, collector 940 executes outside of platform 150. In some embodiments, collector 940 is implemented at a customer site and includes modules for maintaining privacy and security of data collected from databases 135 that can be configured to be active or inactive depending on the nature of the data stored in databases 135 and collected by collector 940. Such embodiments are discussed in further detail in relation to FIGS. 10 and 12.

Metadata aggregator 955 receives the data (e.g., query, table, and extracted metadata) collected and processed by collector 940. Metadata aggregator 955, in some embodiments, aggregates the received query metadata based on a grouping of queries along a shared query metadata attribute that is derived from the query annotation included in the query text data and the query metadata. In some embodiments, metadata aggregator 955 populates a database (e.g., metadata database 115) based on the query and table metadata attributes and additional extracted metadata attributes. For example, a database (or table in the database) is populated with data from the query, table, and extracted metadata attributes in rows for each query including columns for each metadata attribute relating to the query (e.g., any or all of query latency, queuing latency, resource usage, originating application, task, query group, dashboard, tables accessed, etc.).

Display generator 165, in some embodiments, generates a display of query execution performance (e.g., a first graph of query count over time, a second graph of query latency over time, and a third graph of query queuing time over time) for each of a plurality of groups of queries, the plurality of groups having a same value associated with a first query metadata attribute, each group of queries in the plurality of groups of queries having a different value associated with a second query metadata attribute. In some embodiments, a first display is generated that presents a summary of the performance data for the plurality of groups as a whole. The first display, in some embodiments, also includes selectable menus (e.g., dropdown menus) for selecting different metadata attribute values (e.g., selecting an application, task, etc.) for display as subcategories within the summary display. Additional dropdown menus are provided, in some embodiments, to select a single value associated with a metadata attribute to provide further details regarding the query performance. For example, from a first display displaying data for all the queries run by the system, a user can filter the data to select a particular attribute (e.g., application, directed acyclic graph (DAG), task, query group, etc.) to trigger the generation of a second display for queries with the particular attribute. For each of a set of additional displays generated, in some embodiments, the same dropdown menus will be provided to provide the user an ability to filter the data or see further subcategories within the summary display for the selected value associated with the metadata attribute.

In some embodiments, additional displays (e.g., types of views and dashboards) are generated by display generator 165 to provide details regarding certain groupings of queries (e.g., applications, query groups, etc.). In some embodiments, these additional displays include identification of, for example, a set of query groups with the highest value for, or highest percent change in, any or all of query latency, query count, and queuing time. Other generated displays, in some embodiments, include displays relating to table attributes (e.g., table row count over time or table memory usage over time). These additional displays are used, in some embodiments, to provide further insight into issues with specific queries and data pipelines. For example, identifying a table that is rapidly increasing in row count and significantly slowing down a particular query in a data processing pipeline for a machine learning application. FIGS. 14-20, discussed below, provide further details regarding generated displays.

User interface 180 provides a user the ability to interact with platform 150 to (1) control the types of data that are collected by the system and the display generator 165 through controller 185. In some embodiments, user interface 180 includes application programming interfaces (APIs) to control the types of data collected by the system and dashboards (e.g., graphical user interfaces (GUIs)) for users to interact with platform 150 and to modify the generated display. In some embodiments, the APIs are also used to specify the metadata fields included in query annotations by the agents installed in the applications responsible for queries. In some embodiments, the dashboards are accessed through a web browser or thin client by a user.

Platform 150, in some embodiments, is a virtual private cloud that supports the data integration and display features of system 100. As shown, collectors 140, metadata aggregator 155, metadata database 115, display generator 165, and controller 185 execute within platform 150. In some embodiments, the elements executing in platform 150 execute in multiple datacenters over which the virtual private cloud is implemented. Metadata database 115, in some embodiments, is one of a local database (set of one or more servers in the datacenters implementing the virtual private cloud) or a cloud provider database (e.g., Amazon Redshift, etc.).

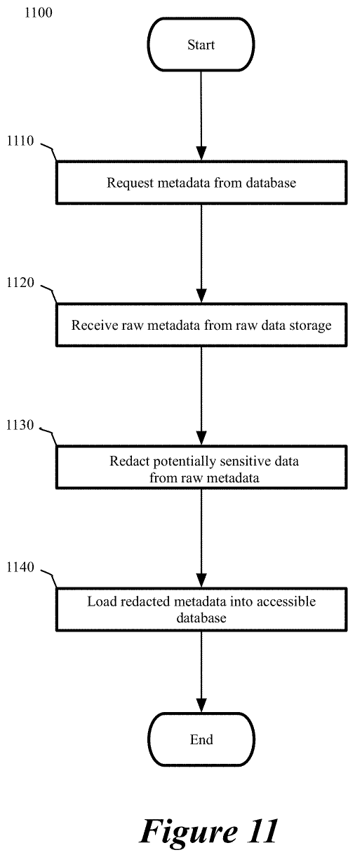

FIG. 10 illustrates a third embodiment of a system 1000. System 1000 is similar to system 100 of FIG. 1, except that the components are split between a secure customer virtual private cloud 1002 and an intermix.io virtual private cloud 1001 in order to keep confidential customer information within the customer's secure system, additional intermediate storages 1036-1038 are introduced to enable security. All the elements of system 1000 that also appear in FIGS. 1 and 9 function as described above for FIGS. 1 and 9 with the exception of the collector 1040. Collector 1040 of system 1000 includes additional modules (unloader 1045 and scrubber 1046) that are active in collector 1040. Components of system 1000 will be explained in conjunction with FIG. 11. FIG. 11 conceptually illustrates process 1100 for collector 1040 to perform to collect and process metadata from databases 135.

Process 1100 begins (at 1110) by requesting data from databases 135. In some embodiments, the request is made by unloader 1045 which is a component of collector 1040 that initiates a data transfer (e.g., unloading) from databases 135 to raw metadata storage 1036 that is a secure storage executing in the customer private cloud 1002. Raw metadata storage 1036 stores the raw metadata, including query text, received from databases 135. In some embodiments, the query text received as part of the raw metadata may include personally identifiable information (PII) and so must be kept within the customer's secure virtual private cloud 1002. To maintain security, for example for regulatory purposes, raw metadata storage 1036 is not accessible from platform 1050.

Process 1100 continues by receiving (at 1120) raw metadata from raw metadata storage 1036, or in some embodiments databases 135, for processing. In some embodiments, raw data storage is a data lake that stores data in different formats received from different databases in the set of databases 135. In order to make the received query metadata available to platform 1050 a separate storage, scrubbed metadata storage 1037, that is accessible from components of platform 1050 is provided. In some embodiments, storages 1036 and 1037 are different buckets (e.g., sets of data with different accessibility) in a data lake (e.g., Amazon S3).

After receiving the raw metadata, collector 1040, using scrubber module 1046, redacts (at 1130) potentially sensitive (e.g., PII) data from the query text stored in raw metadata storage 1036 to comply with customer security and/or confidentiality requirements. The redacting, in some embodiments includes redacting all instances of certain types of query text (e.g., literals, non-annotation comments, etc.) that may contain sensitive data without specifically identifying sensitive data. For example, a query may include a search for data matching a social security number, a name, and/or an address that must remain confidential. Redacting the literals used in the search query removes the specific SSN, name, or address without changing the syntax of the query. Removing the specific types of data (e.g., literals and additional comments not including annotations) from the query text, in some embodiments, does not hinder the identification of query groups because the identification of query groups is based on the syntax of the query (e.g., the columns selected, tables searched, columns searched, types of search conditions, etc.) and not based on the specific terms (i.e., literals) used as conditions in the query. In some embodiments, along with redacting the potentially sensitive data, the scrubber 1046 processes raw metadata received in different formats to conform to a single format used by metadata aggregator 155.

Once the raw metadata is redacted/scrubbed (and formatted), collector 1040 loads (at 1140) the redacted data into scrubbed metadata storage 1037 and process 1100 ends. Once the scrubbed query metadata is stored in scrubbed metadata storage 1037 it is accessible from, and accessed by, local storage 1038 (e.g., an Amazon S3 datalake of VPC 1001) and eventually by metadata aggregator 155. Additional elements of platform 1050 are similar to similarly numbered elements of FIG. 1 (e.g., metadata databases 115 and 1015, Parsers 141-143 and 1041-1043, etc.). System 1000 thus allows the user to access the information necessary for analyzing data flows and pipeline performance in the system without having to provide access to PII or any other information that the user is obligated to keep confidential (e.g., under HIPAA or the payment card industry data security standard (PCI DSS)).

FIG. 12 illustrates a fourth embodiment of a system 1200. System 1200 is similar to system 1000 of FIG. 10, except that the parser modules 1241-1243 have been included in the scrubber module 1212 instead of metadata aggregator 955. Similarly to system 1000, system 1200 maintains data security and confidentiality using raw metadata storage 1036 and scrubbed metadata storage 1037. However, system 1200 includes, as part of scrubber 1212 of collector 1240, query parser 1241, table touch parser 1242, and annotation parser 1243 that perform the functions described above for similarly named modules. In some embodiments, providing all the parsing as part of the scrubbing operation allows for performing fewer parsing operations on the data. In some embodiments, parsing modules 1241-1243 are distributed between the collector 1240 and metadata aggregator 955 or are separate modules from the scrubber module 1246 (not shown). In system 1200 the metadata aggregator 955 is thus presented with scrubbed and processed data for aggregation and loading into metadata database 1015.

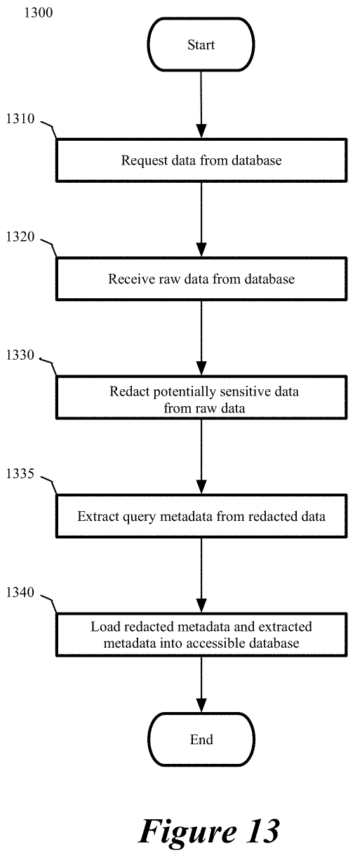

Components of system 1200 will be explained in conjunction with FIG. 13. FIG. 13 conceptually illustrates process 1300 for collector 1240 to perform to collect and process metadata from databases 135. Process 1300 begins (at 1310) by requesting data from databases 135. In some embodiments, the request is made by unloader 1045 which is a component of collector 1240 that initiates a data transfer (e.g., unloading) from databases 135 to raw metadata storage 1036 that is a secure storage executing in the customer private cloud 1002. Raw metadata storage 1036 stores the raw metadata, including query text, received from databases 135. In some embodiments, the query text received as part of the raw metadata may include personally identifiable information (PII) and so must be kept within the customer's secure virtual private cloud 1002. To maintain security, for example for regulatory purposes, raw metadata storage 1036 is not accessible from platform 1050.

Process 1300 continues by receiving (at 1320) raw metadata from raw metadata storage 1036, or in some embodiments databases 135, for processing. In some embodiments, raw data storage is a data lake that stores data in different formats received from different databases in the set of databases 135. In order to make the received query metadata available to platform 1050 a separate storage, scrubbed metadata storage 1037, that is accessible from components of platform 1050 is provided. In some embodiments, storages 1036 and 1037 are different buckets (e.g., sets of data with different accessibility) in a data lake (e.g., Amazon S3).

After receiving the raw metadata, collector 1040, using scrubber module 1046, redacts (at 1330) potentially sensitive (e.g., PII) data from the query text stored in raw metadata storage 1036 to comply with customer security and/or confidentiality requirements. The redacting, in some embodiments includes redacting all instances of certain types of query text (e.g., literals, non-annotation comments, etc.) that may contain sensitive data without specifically identifying sensitive data. For example, a query may include a search for data matching a social security number, a name, and/or an address that must remain confidential. Redacting the literals used in the search query removes the specific SSN, name, or address without changing the syntax of the query. Removing the specific types of data (e.g., literals and additional comments not including annotations) from the query text, in some embodiments, does not hinder the identification of query groups because the identification of query groups is based on the syntax of the query (e.g., the columns selected, tables searched, columns searched, types of search conditions, etc.) and not based on the specific terms (i.e., literals) used as conditions in the query. In some embodiments, removing literals is done in conjunction with processing performed by query processor 1241 discussed below in relation to extracting (at 1335) additional metadata from received query metadata.

Once potentially sensitive data has been redacted, collector 1240 extracts (at 1335) additional metadata from the redacted query metadata. Collector 1240 uses any or all of (1) query parser 1241 to identify query groups (e.g., queries accessing certain tables to extract certain information every 15 minutes, queries searching certain fields of a particular set of tables, etc.) based on the structure of collected query text, (2) table touch parser 1242 to determine tables accessed by each query based on parsing the query text, and (3) annotation parser 1243 to parse the annotations to extract annotation metadata. In addition to redacting potentially sensitive information and extracting additional metadata, collector 1240, in some embodiments, formats the metadata into a format used by metadata aggregator 955. One of ordinary skill in the art understands that, in some embodiments, steps 1330 and 1335 are performed as a single step or in a different order than presented here. Additionally, in some embodiments, only a subset of modules 1241-1243 are used in processing metadata to extract additional metadata (e.g., if some of the modules execute in metadata aggregator 955 instead of collector 1240).

Once the raw metadata is redacted (scrubbed), collector 1040 loads (at 1340) the redacted data and extracted metadata into scrubbed metadata storage 1037 and process 1300 ends. Once the scrubbed query metadata is stored in scrubbed metadata storage 1037 it is accessible from, and accessed by, metadata aggregator 955. Additional elements of platform 1050 are similar to similarly numbered elements of FIGS. 1 and 10 (e.g., metadata databases 115 and 1015, Parsers 141-143 and 1041-1043, etc.). System #4300 thus allows the user to access the information necessary for analyzing data flows and pipeline performance in the system without having to provide access to PII or any other information that the user is obligated to keep confidential (e.g., under HIPAA or the payment card industry data security standard (PCI DSS)).

Once data has been collected parsed and aggregated, the display generator, in some embodiments, generates a display of query execution performance (e.g., a first graph of query count over time, a second graph of query latency over time, and a third graph of query queuing time over time) for each of a plurality of groups of queries, the plurality of groups having a same value associated with a first query metadata attribute, each group of queries in the plurality of groups of queries having a different value associated with a second query metadata attribute. In some embodiments, a first display is generated that presents a summary of the performance data for the plurality of groups as a whole. The first display, in some embodiments, also includes selectable menus (e.g., dropdown menus) for selecting different metadata attribute values (e.g., selecting an application, task, etc.) for display as subcategories within the summary display. Additional dropdown menus are provided, in some embodiments, to select a single value associated with a metadata attribute to provide further details regarding the query performance. For example, from a first display displaying data for all the queries run by the system, a user can filter the data to select a particular attribute (e.g., application, directed acyclic graph (DAG), task, query group, etc.) to trigger the generation of a second display for queries with the particular attribute. For each of a set of additional displays generated, in some embodiments, the same dropdown menus will be provided to provide the user an ability to filter the data or see further subcategories within the summary display for the selected value associated with the metadata attribute.

FIG. 14 illustrates an embodiment of a first display screen that presents a set of graphs (query count 1410, query latency 1420, and queuing latency 1430) for a plurality of queries. FIG. 14 further illustrates two dropdown menus 1404 and 1402 for selecting subgroups to identify and the measure to identify for each subgroup (and the graph as a whole). Dropdown menu 1402, in some embodiments, allows a user to select for display one of a sum of the latency times, an average latency time, a maximum latency time, or a minimum latency time. Dropdown menu 1404, in some embodiments, allows a user to select a subgrouping of data in the graph. In some embodiments, the possible groupings include a combination of users, annotation application (or a metadata attribute included in an annotation such as directed acyclic graph (DAG), task, user_id, etc.), query group, or other query attribute. For example, if the graphs 1410-1430 represent data for a single application, dropdown menu allows a user to depict the query count, latency, and queuing latency for 3 different users using graph areas 1405-1407. Breaking up the graph area by user (or other metadata attribute) allows a user (e.g., system administrator or chief data officer) to identify a particular user (or other grouping based on a metadata attribute) that is experiencing increases in latency that are greater than other users for the same application (or other unifying metadata attribute).

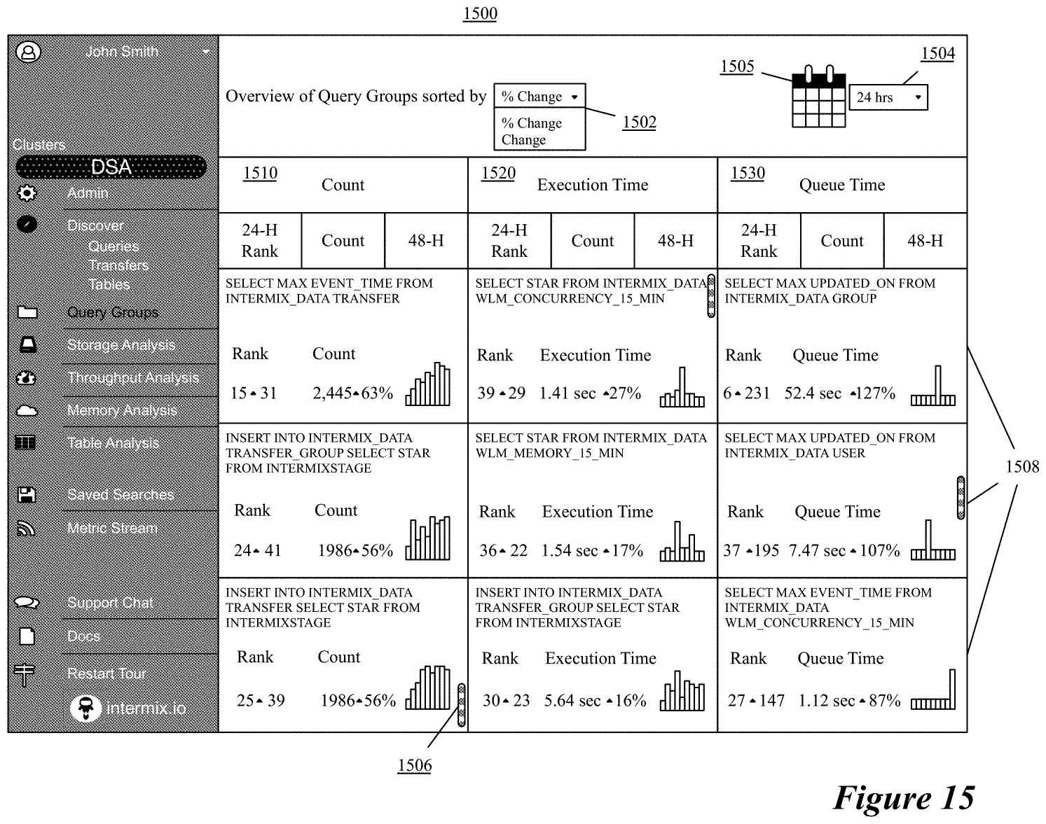

FIG. 15 illustrates a second embodiment of a generated display 1500 that displays information regarding query groups that have had the most significant changes in a specified period of time. Generated display 1500 includes two dropdown menus 1502 and 1504 for selecting a measure of change to use and a timeframe over which to measure the change, respectively. Display 1500 also provides a calendar button 1505 to select a timeframe using a graphical interface. Display 1500 includes three columns 1510-1530 for displaying query groups with the greatest percent change (or absolute change) in count, execution time (i.e., latency), and queue time, respectively. Each query group is represented in a field 1508 and a slider 1506 is provided to scroll through additional entries in each column. Field 1508 includes an indication of the current rank, the rank change and, for columns 1510-1530 respectively, (1) a count and count change (either absolute or measured in percent), (2) an execution time and a change in execution time (either absolute or measured in percent), and (3) queue time and change in queue time (either absolute or measured in percent). Field 1508 also indicates the direction of the change using an up or down arrow and provides a graphical representation of the value for the associated column over, in this embodiment, the last 48 hours. In some embodiments, field 1508 includes a selectable icon that can be used to navigate to a page similar to display 1410 of FIG. 14. One of ordinary skill in the art would appreciate that, instead of using query groups, such displays could be generated based on applications, users, DAGs, tasks, tables, or any other metadata attribute.

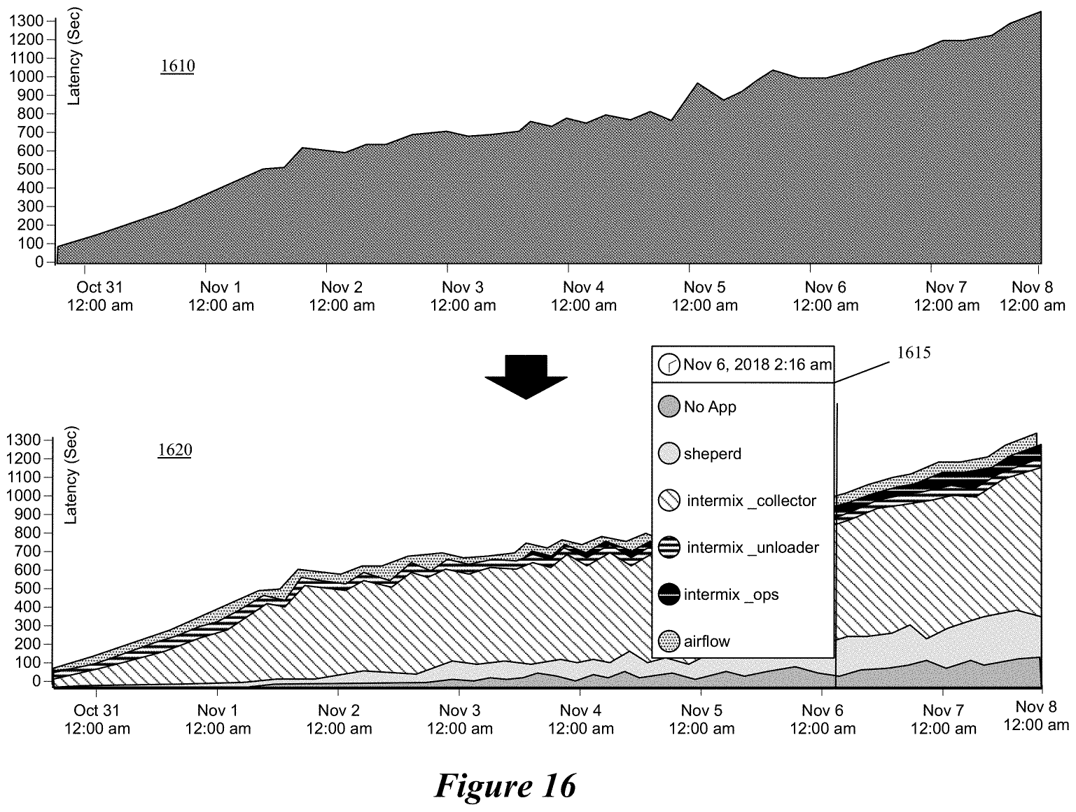

FIGS. 16-20 illustrates a set of displays in a process of “drilling down” into a set of data to discover why a set of queries is slowing down (i.e., increasing in latency). FIG. 16 illustrates graph 1610 of latency (e.g., average latency) over time for a group of queries. In graph 1610 latency for all the queries is depicted and is seen to be increasing over time. In order to determine the cause of the increase a user, in this example, chooses (e.g., using dropdown menus 1402 and 1404) to view the query latency (e.g., using the sum option) broken down by application. Graph 1620 shows the latency of multiple applications including Sheperd, intermix_collector, intermix_unloader, intermix_ops, airflow, and a no App group without an identified application. In this view the user can see that the application named intermix_collector is the source of the increased latency. Legend 1615 is mouse-over text that indicates the applications represented by the different graph areas at the time indicated at the top of legend 1615.

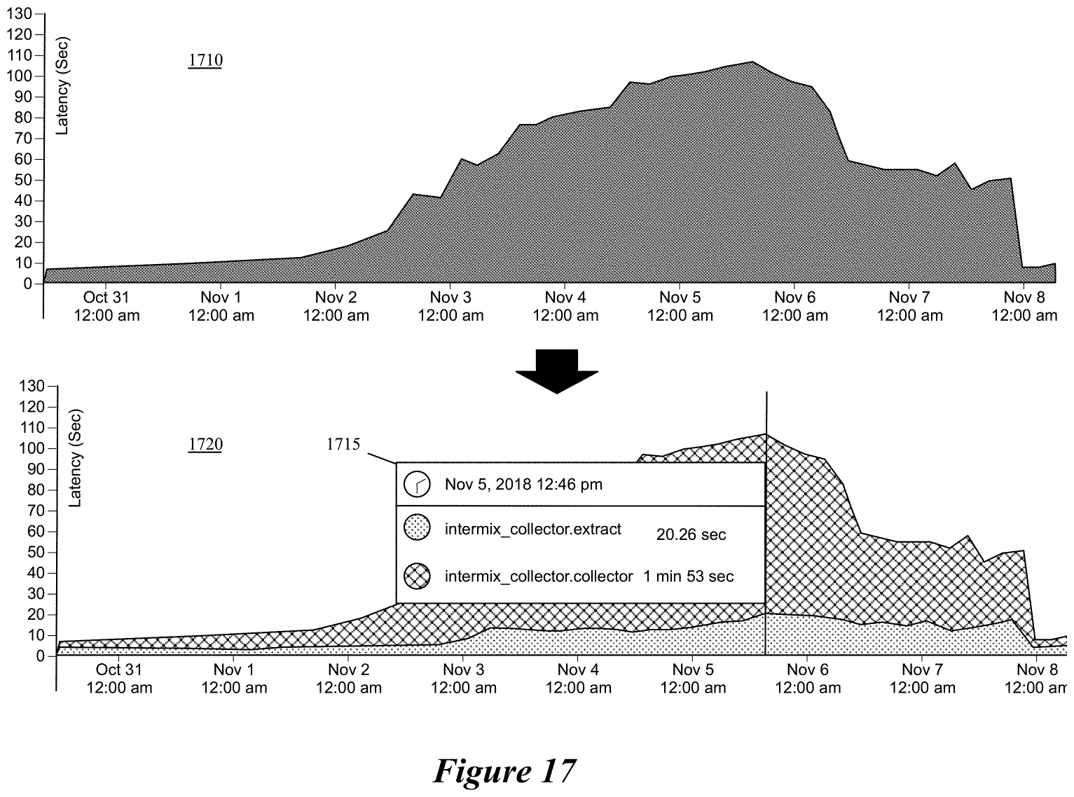

Knowing that intermix_collector is the source of the increased latency, using additional tools (e.g., dropdown menus or other GUIs) not shown in FIG. 14, a user can then further refine the view to provide only queries belonging to the application responsible for the increased query latency. FIG. 17 illustrates a user drilling down by application and then further visualizing the breakdown of the latency by a DAG (i.e., another metadata attribute). FIG. 17 illustrates graph 1710 showing the latency for all queries executed by the intermix_collector app. After further selecting to group latency by another metadata attribute (indicated by the black arrow), FIG. 17 illustrates a refined view 1720 of the intermix_collector application queries which is further broken down by DAG using a “group latency by DAG” option (e.g., in dropdown menu 1404). Using this further refined view allows us to see that the “intermix_collector.collector” DAG is the main driver for the increased latency of the intermix_collector application queries. Legend 1715 is mouse-over text that indicates the DAGs represented by the different graph areas at the time indicated at the top of legend 1715.

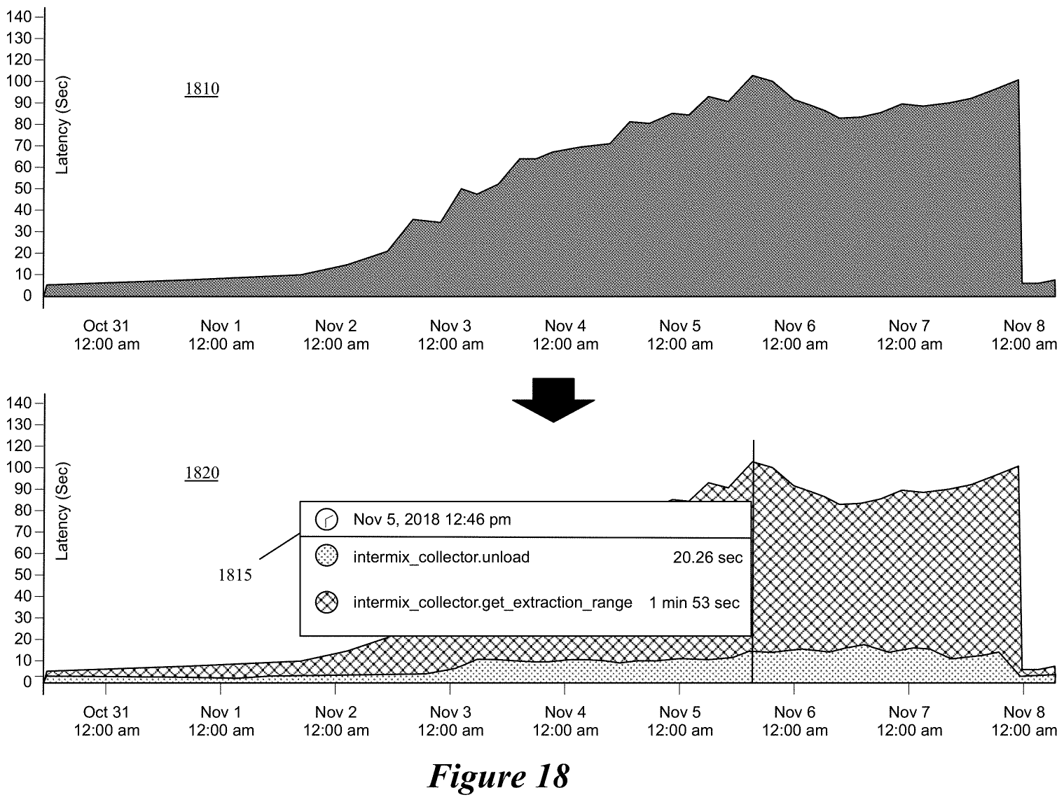

Using the knowledge gained from graph 1720, a user can further refine the view to select only the “collector” DAG of the intermix_collector app. FIG. 18 illustrates a user drilling down by DAG and then further visualizing the breakdown of latency by task. In some embodiments, DAGs can be thought of as including a set of tasks, which may further be broken down into a set of query groups. Different tasks can appear in multiple DAGs and different query groups can appear in multiple tasks (and DAGs). FIG. 18 illustrates graph 1810 of the latency for the collector DAG of the intermix_collector app. After further selecting to group latency by another metadata attribute (indicated by the black arrow), FIG. 18 illustrates a refined view 1820 of the collector DAG of the intermix_collector application queries which is further broken down by task using a “group latency by task” option (e.g., in dropdown menu 1404). Using this view, a user determines that a task named “get_extraction_range” is causing the increase in latency. Legend 1815 is mouse-over text that indicates the tasks represented by the different graph areas at the time indicated at the top of legend 1815.

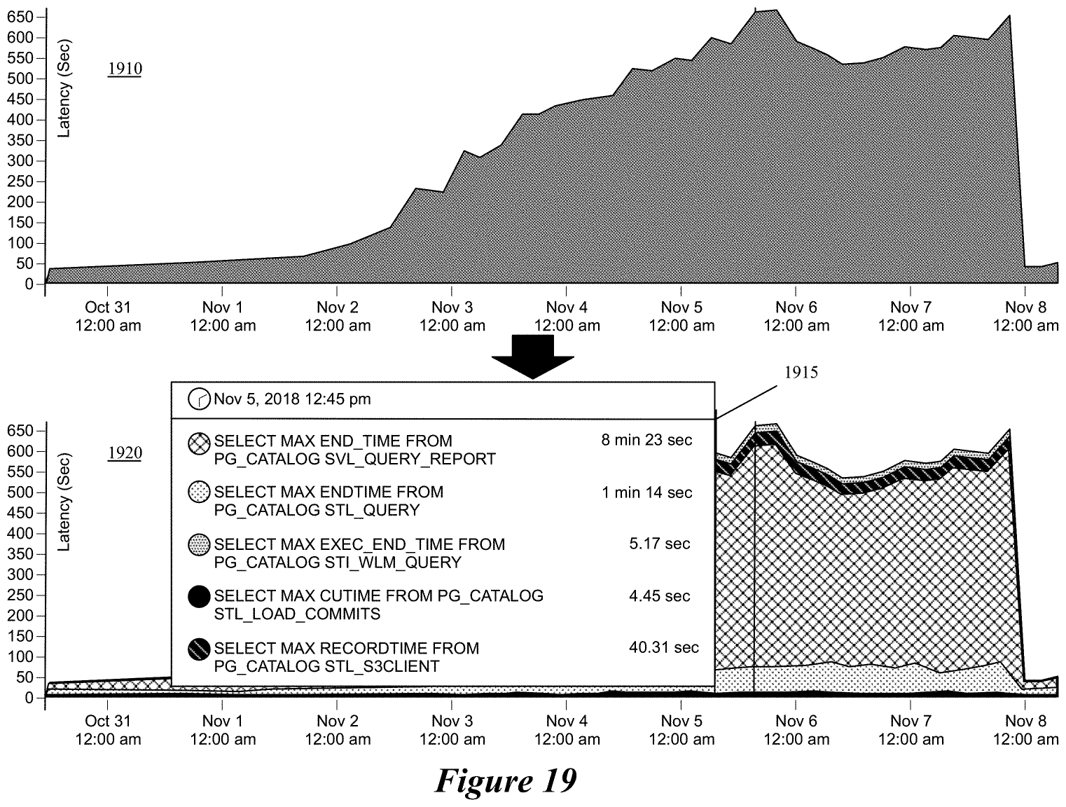

Using the knowledge gained from graph 1820, a user can further refine the view to select only the “get_extraction_range” task of the “collector” DAG of the intermix_collector app. FIG. 19 illustrates a user drilling down by task and then further visualizing the breakdown of latency by query group. As discussed above, query groups reflect query syntax and indicate the tables accessed as well as the columns involved in the access. FIG. 19 illustrates graph 1910 of the latency for the “get_extraction_range” task of the “collector” DAG of the intermix_collector app. After further selecting to group latency by another metadata attribute (indicated by the black arrow), FIG. 19 illustrates a refined view 1920 of the “get_extraction_range” task of the “collector” DAG of the intermix_collector application queries which is further broken down by query group using a “group latency by query group” option (e.g., in dropdown menu 1404). Using this view, a user determines that a query group “SELECT MAX END_TIME FROM PG_CATALOG SVL_QUERY_REPORT” is causing the increase in latency. Legend 1915 is mouse-over text that indicates the query groups represented by the different graph areas at the time indicated at the top of legend 1915.

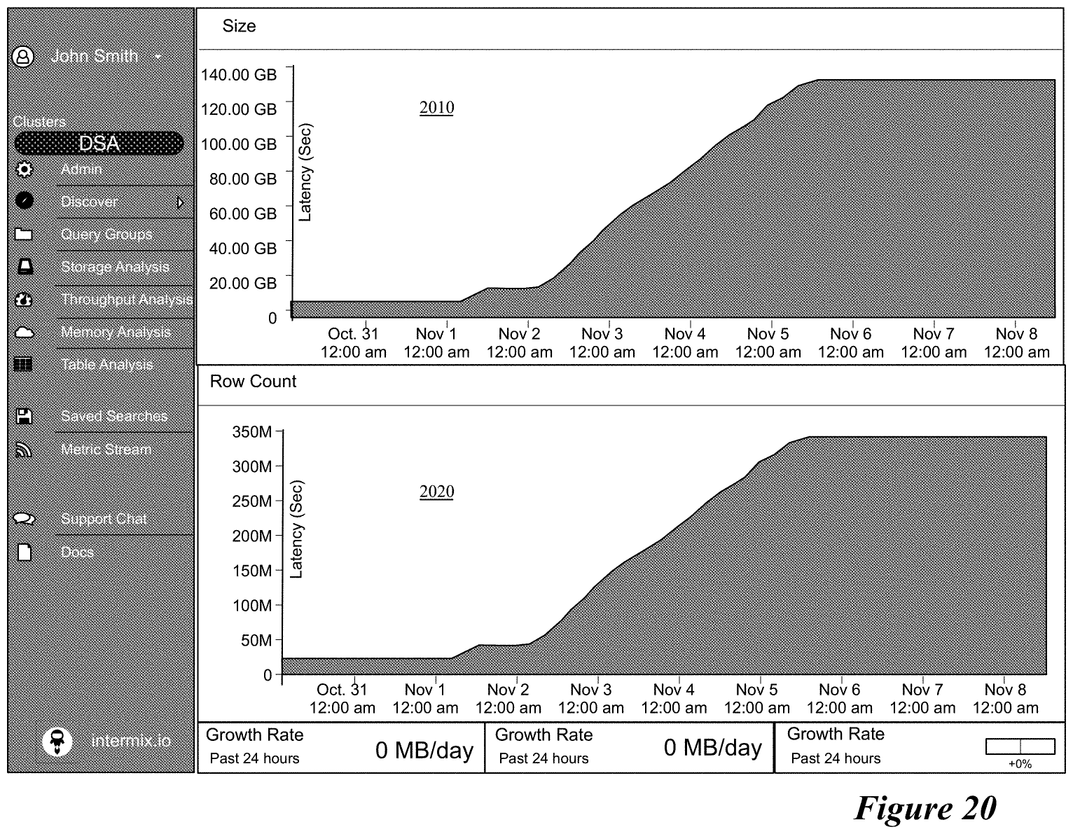

Once a query group causing the increased latency is identified, a user can examine a sample query to determine the tables that might be causing the increased latency. In the example above, a single table is identified in the query group, “pg_catalog.svl_query_report.” FIG. 20 illustrates a display of table metadata including a graph 2010 of table size (in memory) and a graph 2020 of table row count. From graphs 2010 and 2020 it is clear that the size of the table, whether measured in memory or row count has been increasing dramatically as the latency has been increasing, indicating that this table has been the source of the latency.

In some embodiments, the drilling down process described in relation to FIGS. 14-20 is performed by a module or program that drills down into any group of queries experiencing increased latency to automatically identify tables that are causing the increased latency. In some embodiments, the identification is done using the information from the table touch parser described in relation to FIGS. 1, 9, 10, and 12. In some embodiments, the identification first identifies tables that have grown recently and then uses the table touch data to identify query groups that access the table, while in other embodiments, the program identifies query groups that have experienced increased latency beyond a threshold measured either absolutely or relatively (e.g., an increase of 20 seconds or an increase of 100%) and uses the table touch data to identify candidate tables or a specific table that appears to be responsible for the increased latency (i.e., a table that has increased its row count or size by 100% or more).

In some embodiments, the insight provided by the above system can be used to provide information for security-related purposes. For example, by selecting a specific user by which to organize the displayed data, an administrator can see what queries an ex-employee was accessing shortly before they left in order to ensure they were not accessing information outside of the scope of their responsibilities or identify any sensitive information they may have been accessing and taken with them upon leaving. Additionally, the number of queries or CPU or memory resources used can be broken down by user group (e.g., business division) to apportion the cost for database and other information services according to their use. For example, a user could determine that users belonging to a first business division are executing queries that account for 75% of the latency, CPU, and memory while second and third business divisions use 20% and 5% respectively. A naive apportioning of costs would result in each business division paying shares of the costs that are not in line with their use of the application or database but using the system described above each business division could be assigned a share of the cost that reflects their utilization of the application or database.

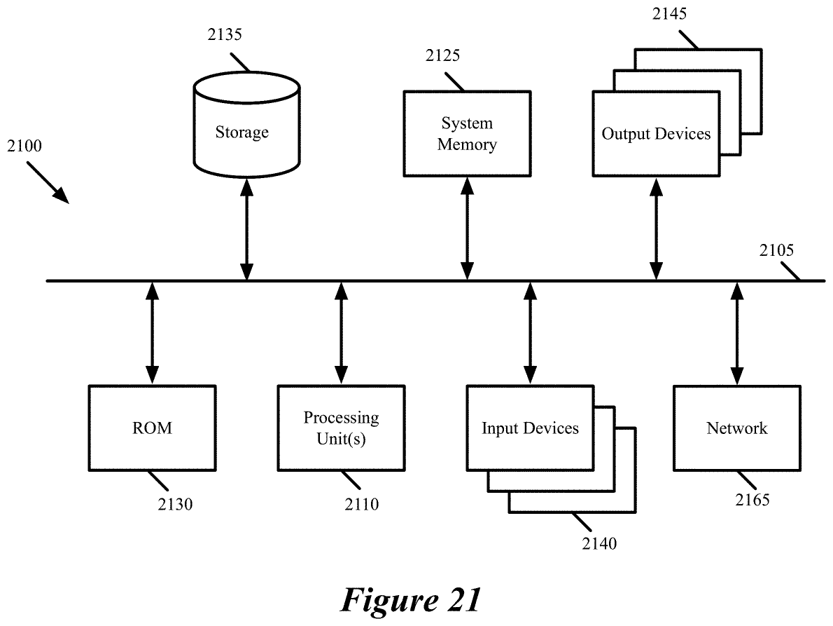

FIG. 21 conceptually illustrates an electronic system 2100 with which some embodiments of the invention are implemented. The electronic system 2100 can be used to execute any of the control, virtualization, or operating system applications described above. The electronic system 2100 may be a computer (e.g., a desktop computer, personal computer, tablet computer, server computer, mainframe, a blade computer etc.), phone, PDA, or any other sort of electronic device. Such an electronic system includes various types of computer readable media and interfaces for various other types of computer readable media. Electronic system 2100 includes a bus 2105, processing unit(s) 2110, a system memory 2125, a read-only memory (ROM) 2130, a permanent storage device 2135, input devices 2140, and output devices 2145.

The bus 2105 collectively represents all system, peripheral, and chipset buses that communicatively connect the numerous internal devices of the electronic system 2100. For instance, the bus 2105 communicatively connects the processing unit(s) 2110 with the read-only memory 2130, the system memory 2125, and the permanent storage device 2135.

From these various memory units, the processing unit(s) 2110 retrieve instructions to execute and data to process in order to execute the processes of the invention. The processing unit(s) may be a single processor or a multi-core processor in different embodiments.

The read-only-memory 2130 stores static data and instructions that are needed by the processing unit(s) 2110 and other modules of the electronic system. The permanent storage device 2135, on the other hand, is a read-and-write memory device. This device is a non-volatile memory unit that stores instructions and data even when the electronic system 2100 is off. Some embodiments of the invention use a mass-storage device (such as a magnetic or optical disk and its corresponding disk drive) as the permanent storage device 2135.

Other embodiments use a removable storage device (such as a floppy disk, flash drive, etc.) as the permanent storage device. Like the permanent storage device 2135, the system memory 2125 is a read-and-write memory device. However, unlike storage device 2135, the system memory is a volatile read-and-write memory, such as random access memory. The system memory stores some of the instructions and data that the processor needs at runtime. In some embodiments, the invention's processes are stored in the system memory 2125, the permanent storage device 2135, and/or the read-only memory 2130. From these various memory units, the processing unit(s) 2110 retrieve instructions to execute and data to process in order to execute the processes of some embodiments.

The bus 2105 also connects to the input and output devices 2140 and 2145. The input devices enable the user to communicate information and select commands to the electronic system. The input devices 2140 include alphanumeric keyboards and pointing devices (also called “cursor control devices”). The output devices 2145 display images generated by the electronic system. The output devices include printers and display devices, such as cathode ray tubes (CRT) or liquid crystal displays (LCD). Some embodiments include devices such as a touchscreen that function as both input and output devices.

Finally, as shown in FIG. 21, bus 2105 also couples electronic system 2100 to a network 2165 through a network adapter (not shown). In this manner, the computer can be a part of a network of computers (such as a local area network (“LAN”), a wide area network (“WAN”), or an Intranet, or a network of networks, such as the Internet. Any or all components of electronic system 2100 may be used in conjunction with the invention.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra-density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some embodiments are performed by one or more integrated circuits, such as application specific integrated circuits (ASICs) or field programmable gate arrays (FPGAs). In some embodiments, such integrated circuits execute instructions that are stored on the circuit itself.

As used in this specification, the terms “computer”, “server”, “processor”, and “memory” all refer to electronic or other technological devices. These terms exclude people or groups of people. For the purposes of the specification, the terms display or displaying means displaying on an electronic device. As used in this specification, the terms “computer readable medium,” “computer readable media,” and “machine readable medium” are entirely restricted to tangible, physical objects that store information in a form that is readable by a computer. These terms exclude any wireless signals, wired download signals, and any other ephemeral signals.

While the invention has been described with reference to numerous specific details, one of ordinary skill in the art will recognize that the invention can be embodied in other specific forms without departing from the spirit of the invention. In addition, a number of the figures conceptually illustrate processes. The specific operations of these processes may not be performed in the exact order shown and described. The specific operations may not be performed in one continuous series of operations, and different specific operations may be performed in different embodiments. Furthermore, the process could be implemented using several sub-processes, or as part of a larger macro process. Thus, one of ordinary skill in the art would understand that the invention is not to be limited by the foregoing illustrative details, but rather is to be defined by the appended claims.

We claim:

1. A method comprising:
receiving query metadata regarding a plurality of queries, said query metadata comprising (1) query text data that includes query annotations inserted as comments that are ignored during query execution and (2) query performance data;
aggregating query metadata based on a grouping of queries along a shared query metadata attribute that is derived from the query annotation included in the query text data; and
from the aggregated query metadata, generating a display of query execution performance for each of a plurality of groups of queries, the plurality of groups having a same value associated with a first query metadata attribute, each group of queries in the plurality of groups of queries having a different value associated with a second query metadata attribute.

2. The method of claim 1, wherein the query performance data comprises at least one of (1) a latency of the query, (2) a start and end time of the query execution, (3) a queueing time, (4) resources used in executing the query, (5) memory used in executing the query, (6) rows accessed in executing the query, and (7) errors in executing the query.

3. The method of claim 1, wherein the annotations comprise a set of data relating to at least one of (1) an originating application, (2) a user of the application, (3) a task related to the query, (4) a group associated with the query, (5) a dashboard associated with the query, (6) a version of the application responsible for the query, (7) directed acyclic graph (DAG), (8) data source, and (9) a time that the query was executed.

4. The method of claim 1, wherein the queries originate from a plurality of applications.

5. The method of claim 4, wherein annotations associated with a particular application in the plurality of applications are added by a plugin of the particular application.

6. The method of claim 1, wherein the query metadata is collected by a collector that is in communication with the plurality of databases to collect the query metadata.

7. The method of claim 1, wherein queries in the plurality of queries are executed on a plurality of databases and access a plurality of tables in at least one database.

8. The method of claim 7, further comprising:
for the plurality of tables, receiving table metadata expressing attributes of the table during a time period that is associated with the plurality of queries; and
correlating the received query and table metadata to identify tables associated with queries in the plurality of queries.

9. The method of claim 8, wherein the table metadata comprises information relating to at least one of (1) a size of the table, (2) the number of rows in the table, (3) the number of columns in the table, (4) the table name, (5) the name of the schema including the table, (6) the name of the database including the table, (7) the skew of the table, (8) the distribution style, (9) the distribution key, (10) the sorting style, and (11) the fraction of the table that is sorted.

10. The method of claim 1, wherein the generated display is provided to a user through an internet browser.

11. A non-transitory computer readable medium storing a program for execution by a set of processing units, the program comprising sets of instruction for:
receiving query metadata regarding a plurality of queries, said query metadata comprising (1) query text data that includes query annotations inserted as comments that are ignored during query execution and (2) query performance data;
aggregating query metadata based on a grouping of queries along a shared query metadata attribute that is derived from the query annotation included in the query text data; and
from the aggregated query metadata, generating a display of query execution performance for each of a plurality of groups of queries, the plurality of groups having a same value associated with a first query metadata attribute, each group of queries in the plurality of groups of queries having a different value associated with a second query metadata attribute.

12. The non-transitory computer readable medium of claim 11, wherein the query performance data comprises at least one of (1) a latency of the query, (2) a start and end time of the query execution, (3) a queueing time, (4) resources used in executing the query, (5) memory used in executing the query, (6) rows accessed in executing the query, and (7) errors in executing the query.

13. The non-transitory computer readable medium of claim 11, wherein the annotations comprise a set of data relating to at least one of (1) an originating application, (2) a user of the application, (3) a task related to the query, (4) a group associated with the query, (5) a dashboard associated with the query, (6) a version of the application responsible for the query, and (7) a time that the query was executed.

14. The non-transitory computer readable medium of claim 11, wherein the queries originate from a plurality of applications.

15. The non-transitory computer readable medium of claim 14, wherein annotations associated with a particular application in the plurality of applications are added by a plugin of the particular application.

16. The non-transitory computer readable medium of claim 11, wherein the query metadata is collected by a collector that is in communication with the plurality of databases to collect the query metadata.

17. The non-transitory computer readable medium of claim 11, wherein queries in the plurality of queries are executed on a plurality of databases and access a plurality of tables in at least one database.

18. The non-transitory computer readable medium of claim 17, wherein the program further comprises sets of instructions for:
for the plurality of tables, receiving table metadata expressing attributes of the table during a time period that is associated with the plurality of queries; and
correlating the received query and table metadata to identify tables associated with queries in the plurality of queries.

19. The non-transitory computer readable medium of claim 18, wherein the table metadata comprises information relating to at least one of (1) a size of the table in memory, (2) the number of rows in the table, (3) the number of columns in the table, (4) the table name, (5) the name of the schema including the table, (6) the name of the database including the table, (7) the skew of the table, (8) the distribution style, (9) the distribution key, (10) the sorting style, and (11) the fraction of the table that is sorted.

20. The non-transitory computer readable medium of claim 11, wherein the program further comprises a set of instructions for providing the generated display to a user through an internet browser.
